(19) United States
(12) Patent Application Publication
(10) Pub. No.: US 2012/0291230 A1
(43) Pub. Date: Nov. 22, 2012

(54) WEDGE TYPE ROPE FASTENING DEVICE FOR ELEVATOR

(75) Inventor: Masahiko Hida, Tokyo (JP)

(73) Assignee: MITSUBISHI ELECTRIC CORPORATION, Tokyo (JP)

(21) Appl. No.: 13/522,986

(22) PCT Filed: Mar. 19, 2010
(86) PCT No.: PCT/JP2010/054824

§ 371 Date: Jul. 19, 2012

(51) Int. Cl. F16G 11/04

(52) U.S. Cl. 24/136 K

(57) ABSTRACT

A wedge-type rope fastening device for an elevator includes: a socket including a through hole formed therethrough, the through hole including a first inner wall surface and a second inner wall surface inclined with respect to the first inner wall surface; and a wedge around which a rope is looped, the wedge including a first outer wall surface and a second outer wall surface inclined with respect to the first outer wall surface, the rope being sandwiched between the first inner wall surface and the first outer wall surface and between the second inner wall surface and the second outer wall surface. An inclination angle of the second outer wall surface relative to the first outer wall surface is larger than an inclination angle of the second inner wall surface relative to the first inner wall surface.

### TECHNICAL FIELD

The present invention relates to a wedge-type rope fastening device for an elevator, which is mounted to an end portion of a rope.

### BACKGROUND ART

Conventionally, there has been known a wedge-type rope fastening device for an elevator, which is configured so that a rope and a wedge are inserted into a through hole formed in a tapered manner through a socket in a state in which a loop portion is formed by bending back an end portion of the rope and the wedge is located inside the loop portion. A tensile load acts on the rope to draw the rope and the wedge into the through hole. As a result, the rope is sandwiched between an inner wall surface of the socket and the wedge (for example, see Patent Literature 1).

### CITATION LIST

### Patent Literature

Patent Literature 1: JP 2006-76791 A

### SUMMARY OF INVENTION

### Technical Problem

When the tensile load acting on the rope becomes larger, however, the wedge is further drawn into the through hole. As a result, a distal end portion of the wedge passes through the through hole to project from the socket. As a result, an area of the rope depressed by the inner wall surface of the socket and the wedge becomes smaller. Consequently, a compressive stress generated in a portion of the rope, which is interposed between the inner wall surface of the socket and the wedge, becomes larger. A portion of the rope, which is located in the vicinity of an outlet of the through hole, has a reduced thickness due to the compressive stress to have a lowered tensile strength. Therefore, there has been a problem in that the action of the tensile load is more likely to cause damage in the portion of the rope, which is located in the vicinity of the outlet of the through hole.

The present invention provides a wedge-type rope fastening device for an elevator, which is capable of reducing occurrence of damage in a rope.

### Solution to Problem

The present invention provides a wedge-type rope fastening device for an elevator, including: a socket including a through hole formed therethrough, the through hole including a first inner wall surface and a second inner wall surface inclined with respect to the first inner wall surface; and a wedge around which a rope is looped, the wedge including a first outer wall surface and a second outer wall surface inclined with respect to the first outer wall surface, the rope being sandwiched between the first inner wall surface and the first outer wall surface and between the second inner wall surface and the second outer wall surface. An inclination angle of the second outer wall surface relative to the first outer wall surface is larger than an inclination angle of the second inner wall surface relative to the first inner wall surface.

### Advantageous Effects of Invention

According to the wedge-type rope fastening device for an elevator of the present invention, the inclination angle of the second outer wall surface relative to the first outer wall surface is larger than the inclination angle of the second inner wall surface relative to the first inner wall surface. Therefore, when the tensile load acts on the rope to draw the rope and the wedge into the through hole, a compressive stress acting on a portion of the rope, which is located in the vicinity of an outlet of the through hole, becomes smaller than a compressive stress acting on a portion of the rope, which is located in the vicinity of an inlet of the through hole. As a result, the occurrence of damage in the portion of the rope, which is located in the vicinity of the outlet of the through hole, is suppressed, with the result that the damage of the rope can be kept unlikely to occur.

### BRIEF DESCRIPTION OF DRAWINGS

FIG. 1 is a front view illustrating a wedge-type rope fastening device for an elevator according to a first embodiment of the present invention.

FIG. 2 is a front view illustrating the wedge-type rope fastening device for an elevator, which is held in a state in which a tensile load acts on a rope illustrated in FIG. 1.

### DESCRIPTION OF EMBODIMENT

### First Embodiment

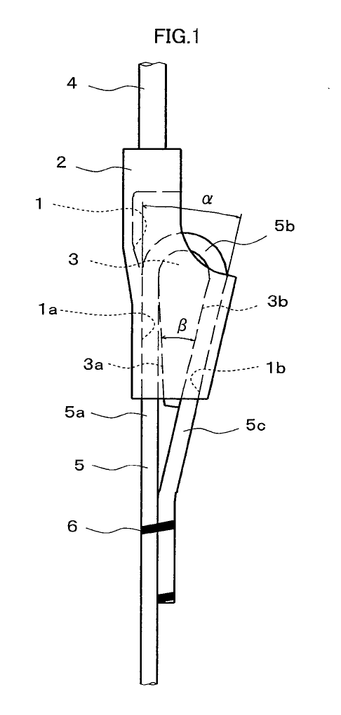

FIG. 1 is a front view illustrating a wedge-type rope fastening device for an elevator according to a first embodiment of the present invention. In FIG. 1, the wedge-type rope fastening device for an elevator includes a socket 2 made of steel, through which a through hole 1 is formed, a wedge 3 made of a polymer material, which is to be inserted into the through hole 1, and a shackle rod 4 fixed to the socket 2. The shackle rod 4 is connected to a hoistway, a car, or a counterweight.

The through hole 1 includes a first inner wall surface 1a and a second inner wall surface 1b inclined with respect to the first inner wall surface 1a. The wedge 3 is inserted from an inlet of the through hole 1 toward an outlet thereof. A distance between the first inner wall surface 1a and the second inner wall surface 1b at the inlet of the through hole 1 is larger than a distance between the first inner wall surface 1a and the second inner wall surface 1b at the outlet of the through hole 1.

The wedge 3 includes a first outer wall surface 3a and a second outer wall surface 3b inclined with respect to the first outer wall surface 3a. The wedge 3 is inserted into the through hole 1 from a portion of the wedge 3, which has a small distance between the first outer wall surface 3a and the second outer wall surface 3b. When the wedge 3 is inserted into the through hole 1, the first outer wall surface 3a and the first inner wall surface 1a are opposed to each other, while the second outer wall surface 3b and the second inner wall surface 1b are opposed to each other.

An inclination angle β of the second outer wall surface 3b relative to the first outer wall surface 3a is larger than an inclination angle α of the second inner wall surface 1b relative to the first inner wall surface 1a. The inclination angler β is equal to or smaller than an angle obtained by adding 3 degrees to the inclination angle α. Specifically, the relationship between the inclination angle α and the inclination angle β satisfies the following Formula (1).

α<β≦+3 (1)

An end portion of a rope 5 is looped around the wedge 3. The end portion of the rope 5 is bent back by being looped around the wedge 3. The rope 5 includes a rope main body 5a, an arc portion 5b, which is provided so as to be continuous from the rope main body 5a and bent in an arc-like shape, and a return portion 5c provided so as to be continuous from a portion of the arc portion 5b on the side opposite to the rope main body 5a. The rope main body 5a extends from the socket 2 toward the side opposite to the shackle rod 4. The return portion 5c is fastened to the rope main body 5a by using a fastener 6.

The wedge 3 is inserted into the through hole 1 in a state in which the rope 5 is looped around the wedge 3. At this time, the rope main body 5a is sandwiched between the first inner wall surface 1a and the first outer wall surface 3a, while the return portion 5c is sandwiched between the second inner wall surface 1b and the second outer wall surface 3b.

Onto the first inner wall surface 1a, the second inner wall surface 1b, the first outer wall surface 3a, and the second outer wall surface 3b, a fluorine coating material (low-friction covering body) for reducing a frictional force acting between the rope 5 and each of those surfaces is applied.

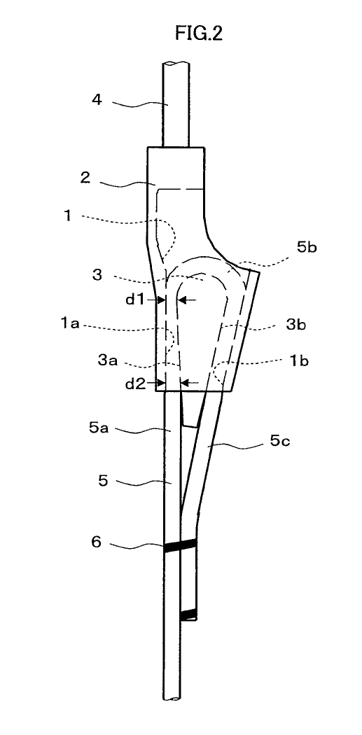

Next, an operation of the wedge-type rope fastening device for an elevator is described. FIG. 2 is a front view illustrating the wedge-type rope fastening device for an elevator, which is held in a state in which a tensile load acts on the rope 5 illustrated in FIG. 1. The tensile load acts on the rope 5 to draw the wedge 3 and the portion of the rope 5, which is looped around the wedge 3, toward the outlet of the through hole 1. As a result of the drawing of the wedge 3 toward the outlet of the through hole 1, the rope main body 5a is sandwiched between the first inner wall surface 1a and the first outer wall surface 3a, while the return portion 5c is sandwiched between the second inner wall surface 1b and the second outer wall surface 3b. Consequently, a compressive stress acts on the rope main body 5a and the return portion 5c. At this time, the inclination angle β of the second outer wall surface 3b relative to the first outer wall surface 3a is larger than the inclination angle α of the second inner wall surface 1b relative to the first inner wall surface 1a. Therefore, the compressive force acting on a portion of the rope main body 5a, which is located in the vicinity of the outlet of the through hole 1, becomes smaller than the compressive force acting on a portion of the rope main body 5a, which is located in the vicinity of the inlet of the through hole 1. Consequently, a thickness d2 of the portion of the rope main body 5a, which is located in the vicinity of the outlet of the through hole 1, becomes larger than a thickness d1 of the portion of the rope main body 5, which is located in the vicinity of the inlet of the through hole 1. As a result, a tensile strength of the portion of the rope main body 5a, which is located in the vicinity of the outlet of the through hole 1, becomes larger than a tensile strength of the portion of the tope main body 5a, which is located in the vicinity of the inlet of the through hole 1.

As described above, in the wedge-type rope fastening device for an elevator according to the first embodiment of the present invention, the inclination angle β of the second outer wall surface 3b relative to the first outer wall surface 3a is larger than the inclination angle α of the second inner wall surface 1b relative to the first inner wall surface 1a. Therefore, when the rope 5 and the wedge 3 are drawn into the through hole 1 by the action of the tensile load on the rope 5, the compressive stress acting on the portion of the rope main body 5a, which is located in the vicinity of the outlet of the through hole 1, becomes smaller than the compressive stress acting on the portion of the rope main body 5a, which is located in the vicinity of the inlet of the through hole 1. Consequently, the tensile strength of the portion of the rope main body 5a, which is located in the vicinity of the outlet of the through hole 1, becomes larger than the tensile strength of the portion of the rope main body 5a, which is located in the vicinity of the inlet of the through hole 1. As a result, the occurrence of damage in the portion of the rope 5, which is located in the vicinity of the outlet of the through hole 1, is suppressed so that the damage of the rope 5 can be kept unlikely to occur. In particular, when a multi-layer strand rope including a large number of outer-layer strands is used as the rope 5 without changing an overall thickness, each of wires serving as the outer-layer strands becomes thinner. As a result, the wires are more likely to be broken. However, the compressive stress acting on the portion of the rope 5, which is located in the vicinity of the outlet of the through hole 1, is smaller than the compressive stress acting on the portion of the rope main body 5a, which is located in the vicinity of the inlet of the through hole 1. Therefore, the wires of the outer-layer strands in the vicinity of the outlet of the through hole 1 are prevented from being disconnected, with the result that the tensile strength of the rope 5 can be enhanced.

Further, the socket 2 is made of steel. Thus, the deformation of the socket 2 can be suppressed when the tensile load acts on the rope 5.

Further, the wedge 3 is made of the polymer material, and hence molding can be easily performed.

Further, the fluorine coating material is applied onto the first inner wall surface 1a and the second inner wall surface 1b. Therefore, the frictional force acting between the first inner wall surface 1a and the rope 5 and between the second inner wall surface 1b and the rope 5 can be reduced. In this manner, even in a case where the rope 5 is covered with a resin having a large friction coefficient, insufficient drawing of the rope 5 into the through hole 1, which occurs due to non-slippage of the rope 5 with respect to the inner wall surface 1a and the second inner wall surface 1b, can be prevented when the tensile load acts on the rope 5. As a result, a reduction in contact area between the first inner wall surface 1a and the rope 5 and between the second inner wall surface 1b and the rope 5, which occurs due to the insufficient drawing of the rope 5 into the through hole 1, can be prevented. As a result, the compressive stress acting from the first inner wall surface 1a and the second inner wall surface 1b on the rope 5 can be prevented from increasing so that the rope 5 can be prevented from being broken.

Further, the fluorine coating material is applied onto the first outer wall surface 3a and the second outer wall surface 3b. Therefore, the frictional force acting between the first outer wall surface 3a and the rope 5 and between the second outer wall surface 3b and the rope 5 can be reduced. In this manner, even in a case where the rope 5 is covered with a resin having a large friction coefficient, the formation of a clearance between the arc portion 5b and the wedge 3, which occurs due to non-slippage of the rope 5 with respect to the first outer wall surface 3a and the second outer wall surface 3b, can be prevented when the tensile load acts on the rope 5. Therefore, the compressive stress acting from the first outer wall surface 3a and the second outer wall surface 3b on the rope 5 can be prevented from increasing so that the rope 5 can be prevented from being broken.

Further, the low-friction covering body is the fluorine coating material. Therefore, the low-friction covering body can be easily provided on the first inner wall surface 1a, the second inner wall surface 1b, the first outer wall surface 3a, and the second outer wall surface 3b.

Note that, in the first embodiment described above, the wedge-type rope fastening device for an elevator, in which the low-friction covering body is applied onto the first inner wall surface 1a, the second inner wall surface 1b, the first outer wall surface 3a, and the second outer wall surface 3b, has been described. However, the wedge-type rope fastening device for an elevator may include the first inner wall surface 1a, the second inner wall surface 1b, the first outer wall surface 3a, and the second outer wall surface 3b which are exposed without being applied with the low-frequency covering body. Alternatively, the wedge-type rope fastening device for an elevator may include the low-friction covering body which is provided only to any one of the first inner wall surface 1a, the second inner wall surface 1b, the first outer wall surface 3a, and the second outer wall surface 3b.

Further, in the first embodiment described above, the low-friction covering body provided to the first inner wall surface 1a, the second inner wall surface 1b, the first outer wall surface 3a, and the second outer wall surface 3b is the fluorine coating material. However, the low-friction covering body is not limited to the fluorine coating material and may be metal plating.

### REFERENCE SIGNS LIST

1 through hole, 1a first inner wall surface, 1b second inner wall surface, 2 socket, 3 wedge, 3a first outer wall surface, 3b second outer wall surface, 4 shackle rod, 5 rope, 5a rope main body, 5b arc portion, 5c return portion, 6 fastener.

1. A wedge-type rope fastening device for an elevator, comprising:
a socket including a through hole formed therethrough, the through hole including a first inner wall surface and a second inner wall surface inclined with respect to the first inner wall surface; and
a wedge around which a rope is looped, the wedge including a first outer wall surface and a second outer wall surface inclined with respect to the first outer wall surface, the rope being sandwiched between the first inner wall surface and the first outer wall surface and between the second inner wall surface and the second outer wall surface,
wherein an inclination angle of the second outer wall surface relative to the first outer wall surface is larger than an inclination angle of the second inner wall surface relative to the first inner wall surface.

2. A wedge-type rope fastening device for an elevator according to claim 1, wherein the socket is made of steel.

3. A wedge-type rope fastening device for an elevator according to claim 1, further comprising a low-friction covering body provided to at least one of the first inner wall surface, the second inner wall surface, the first outer wall surface, and the second outer wall surface, for reducing a frictional force acting between the rope and the at least one of the first inner wall surface, the second inner wall surface, the first outer wall surface, and the second outer wall surface.

4. A wedge-type rope fastening device for an elevator according to claim 3, wherein the low-friction covering body comprises a coating material.

5. A wedge-type rope fastening device for an elevator according to claim 3, wherein the low-friction covering body comprises metal plating.
